(19) United States
(12) Patent Application Publication
(10) Pub. No.: US 2026/0083156 A1
(43) Pub. Date: Mar. 26, 2026

(54) PROCESS FOR PRODUCING DRIED FISH MEAL

(71) Applicant: Haarslev Industries A/S, Søndersø (DK)

(72) Inventor: Birgir Karl Finnbogason, Søndersø (DK)

(21) Appl. No.: 19/111,934

(22) PCT Filed: Sep. 11, 2023
(86) PCT No.: PCT/EP2023/074856

§ 371 Date: Mar. 14, 2025

(30) Foreign Application Priority Data
Sep. 15, 2022 (DK) PA202200845

(51) Int. Cl. A23K 10/22; A23B 4/03; A23J 1/04; A23K 10/26; A23K 30/20

(52) U.S. Cl. CPC A23K 10/22; A23B 4/03; A23J 1/04; A23K 10/26; A23K 30/20

(57) ABSTRACT

The present invention relates to a method for providing a dried fish meal product from a fish material, the method comprising (i) providing a fish material; (ii) subjecting the fish material to a pre-treatment where the water content of the fish material is reduced, wherein the pre-treatment comprises a first drying step, resulting in a pre-dried fish material, wherein the pre-dried fish material has a moisture content in the range of 15-50% (w/w) water; and (iii) subjecting the pre-dried fish material to a second drying step resulting in a dried fish product; wherein the second drying step performed in step (iii) is a spin flash drying process.

### TECHNICAL FIELD OF THE INVENTION

The present invention relates to a process for producing a dried fish meal product. In particular, the present invention relates to a process for producing a dried fish meal product using two step drying process for improving the quality and productivity of producing the dried fish meal product.

### BACKGROUND OF THE INVENTION

Fishmeal is a dried marine powder that holds several nutritional qualities, which makes it very attractive as a protein supplement in feed, e.g. for animal, for aquacultural and agricultural feeds.

The composition of micronutrients in fishmeal, including proteins, peptides, amino acids, vitamins and minerals, support growth and optimal physiological function of animals and farmed fish.

Processing of fish products may results in two interesting and high value products, namely fishmeal and fish oil, which provides various essential nutritional value due to a high content of:

Fish meal products
Easily digested proteins,
Specific amino acids (in particular, methionine, lysine),
Important minerals (in particular, calcium, phosphorus, magnesium, potassium and selenium),
Vital marine phospholipids,
Essential vitamins (in particular, vitamin B1, B2, B6 and B12).

Fish oil
Healthy long chain omega-3 fatty acids (in particular, EPA, DHA),
Essential vitamins (in particular, vitamin D).

The purpose of the processing of fish materials is to separate the three main components of the raw material, i.e. solids (fat-free dry matter), oil and water. The following processing steps are included.:
(i) heating, is performed to coagulate and sediment the proteins in the fish material. The heating also rupture the fat depots and liberates oil and water. The most common practice of cooking good fish raw materials is to heat the fish material to 95-100° C. within 15 to 20 minutes. The proof of a good cooking is good pressability of the cooked fish material, which leads to proper removal of a liquid fraction from a solid fraction (comprising the coagulated proteins), where it is desirable to provide an efficient recovery of oil, and producing a fish meal product with a low-fat content (which is one of the criterion of quality of fish meal products).
(ii) separation (by pressing or centrifugation), which removes a large liquid fraction from the solid fraction. Pressing has the purpose of squeezing out as much liquid (comprising oil and water) from solid fraction. This is important not only to improve the oil yield (the liquid fraction) and the quality of the meal (the solid fraction), but also to reduce the moisture content of the solid fraction as far as possible, thereby reducing the energy consumption of the dryers and increasing their capacity.
(iii) dividing the liquid fraction into oil and water (stick water). The process of dividing the press liquid into an oil fraction and a water fraction, may be based on their different specific gravities. For efficient separation, centrifugation may be used, however an important prerequisite for this separation is high temperature, implying that the press liquid (comprising oil and stick water) should be reheated to 90-95° C. before subjected to separation into an oil fraction and a water fraction (stick water).
(iv) evaporation of the stick water into a concentrate. By evaporation the solid content of the stick water may be concentrated from 6% dry matter to about 30% dry matter.
(v) drying of the solid fraction (the coagulated fish material) removes sufficient water from the wet solid fraction to produce a stable dry fish meal product. The prime reason for drying is to reduce the moisture content of the non-aqueous material to such a level that insufficient water remains in the fish meal product to support growth of micro-organisms which remains in the dried fish meal product. Furthermore, drying also ensures that the moisture level is sufficiently low to stop chemical degradation of the fish meal product, e.g. reducing oxidation of oils remaining in the dry fish meal product. It is necessary to dry the solid fraction as quickly as possible from a moisture content of 45-60% to a moisture content of 12% moisture or less. Drying is the process step that affects the protein quality most. The fish proteins are affected when exposed to high temperatures for long periods. This affects the nutritional value of meal.
(vi) milling of the dried solid material (the dried fish meal). Following drying, the fish meal product need to be milled in order to obtain the desired particle size of the dry fish meal product. Traditional processing of fish meal require the fish meal to be milled otherwise it may be too coarse for feed mixes. On the other hand excessive fine particles must be avoided as they may cause dusting when handled, sift through woven bags resulting in loss and in pollution and cause compacting of bulk meal.

It is well-known to perform drying with the combination of contact drying and air drying of fish materials for producing dry fish meal product. However, one of the challenges with the presently available processes is the relatively long exposure of the fish material (including the fats and oils) to heat and oxygen increasing the extent of oxidation of fish oils, in particular fish oils being sensitive to oxidation, like the omega 3 fatty acids eicosapentaenoic acid (EPA) and docosahexaenoic acid (DHA).

Thus, there is a need in the industry to find other ways to produce dry fish meal products which are gentler to the fish oils being sensitive to oxidation and which has sufficient capacity.

Hence, an improved process for producing a dry fish meal product would be advantageous, and in particular a more efficient, reliable, gentler, more environmentally friendly, high capacity, less energy consuming and/or cheaper process for providing a dry fish meal product, without compromising, or even improving, the nutritional effect of the dry fish meal product, would be advantageous.

### SUMMARY OF THE INVENTION

Thus, an object of the present invention relates to a process for producing a dried fish meal product.

In particular, it is an object of the present invention to provide a process for producing a dried fish meal product using a two-step drying process for improving the quality and productivity of producing the dried fish meal product that solves the above mentioned problems of the prior art with efficiency, reliability, capacity, costs, tendency to damage the dry fish meal product, in a more environmental friendly process without compromising the nutritional value of the dried fish meal product.

Thus, one aspect of the invention relates to a method for providing a dried fish meal product from a fish material, the method comprising:
(i) Providing a fish material;
(ii) subjecting the fish material to a pre-treatment where the water content of the fish material is reduced, wherein the pre-treatment comprises a first drying step, resulting in a pre-dried fish material, wherein the pre-dried fish material has a moisture content in the range of 15-50% (w/w) water; and
(iii) subjecting the pre-dried fish material to a second drying step resulting in a dried fish product; wherein the second drying step performed in step (iii) is a spin flash drying process.

A further aspect of the present invention relates to the use of a spin flash dryer for producing a dried fish meal product.

Yet an aspect of the present invention relates to a method for preparing a dried fish meal products from a fish material, the method comprising the steps of:
(a) Providing a Fish Material;
(b) Coagulating the fish material, providing a coagulated fish material;
(c) Draining the coagulated fish material providing a solid fraction and a liquid fraction;
(d) subjecting the coagulated fish material to a pre-treatment where the water content of the fish material is reduced, wherein the pre-treatment comprises a first drying step, resulting in a pre-dried fish material, wherein the pre-dried fish material has a moisture content in the range of 15-50% (w/w) water; and
(e) subjecting the pre-dried fish material to a second drying step resulting in a dried fish product;
wherein the second drying step performed in step (e) is a spin flash drying process.

Another aspect of the present invention relates to a system comprising a first dryer which may be in fluid connection with a spin flash dryer.

Yet another aspect of the present invention relates to a fish meal product obtainable by the process according to the present invention.

Still another aspect of the present invention relates to a fish meal product comprising a pepsin digestibility or a true digestibility above 80% and a particle size when measured as d50 in volume fraction, as measured with laser diffraction using a dry powder Beckman Coulter particle size analyser, is between about 20 um and about 0.7 mm and the d90 is below about 1 mm.

In a further aspect of the present invention relates to a use of the fish meal product according to the present invention as a feed ingredient.

In another aspect of the present invention relates to a feed product comprising the fish meal product according to the present invention.

The present invention will now be described in more detail in the following.

### DETAILED DESCRIPTION OF THE INVENTION

Accordingly, the inventors of the present invention surprisingly found that drying a fish material to a fish meal product using a spin flash dryer, or preferably in combination with a pre-drying process (using contact drying, e.g. using disc drying or air drying (different from spin flash drying) may provide a significant reduction in the air flow, the energy necessary for drying the product and thus, are more gentle to the environment and to the product providing high product quality in an economical interesting manner, and thereby improving the productivity and quality of the dry fish meal product provided, even since large amounts of water often needs to be removed from the fish materials to provide the dried fish meal product.

The inventors of the present invention observed that one of the challenges with using a spin flash dryer alone for drying the fish material, e.g. a coagulated fish material, may be that the moisture content of the fish material entering the spin flash dryer may be very high whereby the capacity of spin flash dryer may compromise the productivity, costs and/or even the of the resulting dried fish meal product, alternatively the physical dimensions of the spin flash dryer should be adjusted, resulting in uneconomical and uninteresting constructions and operational costs, which may also compromise the quality of the resulting dried fish meal product. Thus, the inventors of the present invention found that the process may be even further improved by introducing a step of pre-drying the fish material.

Hence, a preferred embodiment of the present invention relates to the use of a spin flash dryer for producing a dried fish meal product.

Another preferred embodiment of the present invention relates to a method for providing a dried fish meal product from a fish material, the method comprising:
(i) providing a fish material;
(ii) subjecting the fish material to a pre-treatment where the water content of the fish material is reduced, wherein the pre-treatment comprises a first drying step, resulting in a pre-dried fish material, wherein the pre-dried fish material has a moisture content in the range of 15-50% (w/w) water; and
(iii) subjecting the pre-dried fish material to a second drying step resulting in a dried fish product; wherein the second drying step performed in step (iii) is a spin flash drying process.

A further preferred embodiment of the present invention relates to a method for preparing a dried fish meal products from a fish material, the method comprising the steps of:
(a) Providing a fish material;
(b) coagulating the fish material, providing a coagulated fish material;
(c) draining the coagulated fish material providing a solid fraction and a liquid fraction;
(d) subjecting the coagulated fish material to a pre-treatment where the water content of the fish material is reduced, wherein the pre-treatment comprises a first drying step, resulting in a pre-dried fish material, wherein the pre-dried fish material has a moisture content in the range of 15-50% (w/w) water; and
(e) subjecting the pre-dried fish material to a second drying step resulting in a dried fish product;

wherein the second drying step performed in step (e) may be a spin flash drying process.

Preferably, the second drying step may be a spin flash drying process. The spin flash dryer may in addition to spin flash dryers refer to air-turbulence mills; turbulent air grinding mills; vortex air mills; spin driers and grinders; flash dryers and grinders. All these are basically characterised by drying and milling wet hydrolysed material in a short period of time.

In an embodiment of the present invention the pre-dried fish material may, at the same time, or substantially at the same time, as being dried, be subjected to milling of the pre-dried fish material.

This, simultaneous, or substantially simultaneous, drying and milling may provide further improvement of the in vitro digestibility and material characteristics of the dried fish meal product, because the small particles that result from the milling action assist in quickly drying the pre-dried fish material.

Thus, the drying process according to the present invention as provided in step (iii) may provide a reliable milling and gas (preferably air) drying system that enables maintaining the integrity of the high-value protein chains in hydrolysed material and in pre-dried fish material.

In an embodiment of the present invention the fish material provided in step (i) may be a coagulated fish material obtained from the fish material.

Preferably the fish material may be subjected to a coagulation process resulting in a full or a partly coagulated fish material. The coagulated fish material may include coagulation of the proteins, or part of the proteins, in the fish material. By coagulating the proteins, or part of the proteins, in the fish material, water and oil bound in the fish material may be liberated resulting in a solid fraction and a liquid fraction.

The coagulation process, resulting in the coagulated fish material, may be selected from a heat treatment, an enzymatic treatment, a chemical treatment, or a combination hereof. Preferably, the coagulation process includes a heat treatment of the fish material resulting in a full or partly coagulated fish material.

In an embodiment of the present invention the heat treatment of the fish material resulting in a full or partly coagulated fish material may be a cooking process.

Fish material may be a suitable source of good quality protein which are essential for health. Fish may be cooked in different ways such as boiling, baked, frying and grilling. These cooking methods may result in enhancing flavor, taste and improve the digestibility and inactivate the pathogenic microorganisms. During cooking of fish, some chemical and physical reactions take place such as protein denaturation that increases its digestibility and improves the nutritional value. Meanwhile, the contents of compounds, like fat-soluble vitamins, fats, oils or polyunsaturated fatty acids may be liberated from the structure and enters into a liquid fraction.

In an embodiment of the present invention the cooking process of the fish material may be performed by heating the fish material in the presence of water.

The moisture content of the fish material during the cooking process, the cooking time and the temperature are parameters well-known in the industry.

The fish material may be moved through a cooker by a screw conveyor or by pressure.

In an embodiment of the present invention the cooker may be a long, steam-jacketed cylinder—preferably a compact coagulator. The compact coagulator may be a horizontal, self-cleaning heat exchanger that uses indirect steam for heating to cook the fish material so the fish material may be probably coagulated and becomes prepared to effective downstream separation.

This process step may be controlled, as incomplete cooking may cause that liquid (water and oil) in the fish material cannot be probably separated and overcooking may result in a fish material being too soft for pressing.

The coagulation process may not involve drying but may result in a coagulation of the proteins or part of the proteins in the fish material.

After the coagulation process the coagulated fish material may be subjected to a separation process for removing a liquid fraction from a solid fraction.

The coagulation process may result in a water fraction, an oil fraction and a solid fraction. Preferably the solid fraction comprises the fish material, or the coagulated fish material.

The temperature of the heat coagulated fish material may be in the range of 80-99° C., such as in the range of 85-98° C., e.g. in the range of 90-97° C., such as in the range of 93-96° C., e.g. about 95° C.

The coagulation process may proceed for 1-120 minutes, such as for 10-100 minutes, e.g. for 15-60 minutes, such as for 20-30 minutes.

Preferably, the moisture content of the coagulated fish material may be in the range of 50-90% (w/w), such as in the range of 60-80% (w/w), e.g. in the range of 65-75% (w/w), such as about 70% (w/w).

The fat content of the fish material or the coagulated fish material, may be in the range of 2-25% (w/w) depending on the fish species, the parts of the fish used for the dried fish meal product, the season, the parts of the fish used for the dried fish meal product, etc. Preferably, the fish material and/or the coagulated fish material may have a fat content in the range of 5-20% (w/w), such as in the range of 10-18% (w/w), e.g. in the range of 12-15% (w/w).

Coagulation, such as cooking, of the fish material may be controlled to provide good separation, e.g. pressability, of the fish material which may leads to proper removal of the liquid fraction from the solid fraction and, in respect of fatty fish species, efficient removal and recovery of oil (which is a high value product), as well as providing a meal with low fat content, which may be a criterion of fish meal quality. The skilled person would know how to optimize the coagulation process, e.g. the cooking treatment, of the fish material to provide good separation, such as pressability, of the coagulated fish material.

In an embodiment of the present invention the separation process of the fish material may result in a solid fraction and a liquid fraction. The fish material may be subjected to a separation process (separating the solid fraction and the liquid fraction) resulting in a solid fraction and a liquid fraction.

The liquid fraction may comprise water, oils and dissolved and suspended protein, vitamins and minerals.

The solid fraction may comprise mainly proteins.

The liquid fraction and the solid fraction may be separated by pressing, filtration or decanting. Preferably, the liquid fraction and the solid fraction may be separated by using a 2-phase decanter or a 3-phase decanter. Preferably, a 3-phase decanter.

The water fraction, the oil fraction and the solid fraction may be separated by decanting using a 3-phase decanter.

The oil fraction may be subjected to further purification processes e.g. by a skimming process and/or a polishing process to further reduce the water and solid content in the oil fraction.

The water fractions obtained from separation process, the skimming process and/or the polishing process may be called stick water.

The stick water, in particular the stick water from the separation process, may be recircled from the separator, e.g. from the press unit and/or the decanting unit (such as a 3-phase decanter), to the cooker which may limit the usage of water added to the process. Furthermore, the stick water may also be warm from the cooking process, and the heat from the stick water may be used for heating the fish material introduced into the cooker, reducing the energy consumption necessary for the heating treatment in the coagulation process.

In an embodiment of the present invention the fish material may have a moisture content above 50% (w/w), such as above 55% (w/w), e.g. above 60% (w/w), such as above 65% (w/w), e.g. above 70% (w/w), such as above 75% (w/w), e.g. above 80% (w/w), such as in the range of 50-90% (w/w), e.g. in the range of 55-85% (w/w), such as in the range of 60-80% (w/w); e.g. in the range of 65-75% (w/w), such as in the range of 60-70% (w/w); e.g. in the range of 62-65% (w/w).

Removal of water from the fish material may be crucial for the resulting dried highly digestible product since the water removal may have significant influence on productivity, yield of dried fish meal product, digestibility of the dried fish meal product, and the cost of the process, because removal of water requires a lot of energy, heat, air flow and handling.

In an embodiment of the present invention, the heat treatment may be performed at a temperature (at atmospheric pressure) below 110° C., more preferably below 95° C., more preferably below a temperature below 90° C., more preferably below 85° C. Preferably, the heat treatment may be performed at a temperature (at atmospheric pressure) in the range of 40-110° C., e.g. in the range of 45-100° C., such as in the range of 50-95° C., e.g. in the range of 60-90° C., e.g. in the range of 65-85° C., such as in the range of 70-80° C.

Preferably, the coagulation process may include a heat treatment at a temperature (at atmospheric pressure) in the range of 60-110° C., e.g. in the range of 70-105° C., such as in the range of 80-103° C., e.g. in the range of 85-100° C., e.g. in the range of 90-99° C., such as in the range of 92-98° C., e.g. in the range of 94-96° C., such as about 95° C.

In an embodiment of the present invention the fish material comprises an oil content of less than 18% (w/w), such as below 15% (w/w), e.g. below 12% (w/w), such as 10% (w/w), such as below 8% (w/w), e.g. below 6% (w/w), such as below 4% (w/w), e.g. below 3% (w/w), such as below 2% (w/w). The fat content of the fish material or the coagulated fish material, may be in the range of 2-25% (w/w), such as in the range of 5-20% (w/w), such as in the range of 10-18% (w/w), e.g. in the range of 12-15% (w/w).

The first drying step of the fish material (pr preferably of the solid fraction) may include an air drying process, a contact drying process, or a combination hereof.

In an embodiment of the present invention the pre-drying may be performed at temperatures below 100° C.; more preferably, at temperatures below 90° C.; even more preferably at temperatures below 80° C.; even more preferably at temperatures below 75° C.

Preferably, pre-drying may be performed at reduced pressure to keep the temperature during the pre-drying low.

Various driers may be used for the pre-drying. Preferred dryers are those that gently removes water from the fish material. Furthermore, dryers capable of running with large volumes may be preferred.

In an embodiment of the present invention the pre-drying may include a dryer that gently removes water from the fish material and that is capable of running with large volumes may be preferred.

Dryers capable of running with large capacities may include a disc dryer, a drum dryer, a coil dryer, a condi dryer, or a hot air dryer. Hot air dryers may include a ring dryer, a fluidized bed dryer

Preferably, the dryer used for pre-drying may be steam dryer or contact dryer, such as a disc dryer, a coil dryer, a condi dryer, rotor tube dryer, or a paddle dryer. Even more preferably, the dryer used for pre-drying may be a disc dryer, or a condi dryer. Even more preferably, the dryer used for pre-drying may be a disc dryer.

Even more preferably, the dryer used for pre-drying may be a vacuum disc dryer. Even vacuum disc dryers have shown to be suitable for dying fish material, and may be used in the pre-drying, vacuum disc dryers maybe impose unnecessary costs to the process since the pre-drying does not perform a full drying of the fish material and then the influence of the increased temperature on the resulting dried fish meal product, may be considered insignificant.

Preferable the pre-drying of the fish material may be performed in a dryer at a temperature/time/pressure combination which limits the drop in pepsin digestibility and/or in true digestibility by less than 10%, such as less than 8%, e.g. less than 6%, and/or such that the pepsin digestibility and/or that the pepsin digestibility may be higher than 75%, such as higher than 80%, e.g. higher than 85%.

Gentle removal of water may include removal of water under conditions (in particular time, temperature and pressure) where the drop in digestibility during the pre-drying is less than 10%, such as less than 8%, e.g. less than 6%, such as less than 4%, e.g. less than 2%, such as less than 1%, e.g. less than 0.1%.

Preferably, the air dryer (performing the air-drying of the first drying step) may be performed by using a flow of hot air, such as in a flash dryer, a fluidized bed dryer, a ring-type dryer, a rotating flash dryers or the like.

The contact drying process may be performed by a contact dryer. The contact dryer may preferably be a disc dryer, a coil dryer, a condi dryer, rotor tube dryer, or a paddle dryer. Preferably, the first drying step provided may be performed by a contact dryer, in particular a disc dryer.

The fist drying step may result in a pre-dried fish material, wherein the pre-dried fish material may have a moisture content in the range of 15-50% (w/w) water, such as in the range of 20-45% (w/w) water, e.g. in the range of 25-43% (w/w) water, such as in the range of 30-40% (w/w) water, e.g. in the range of 32-38% (w/w) water, such as about 35% (w/w) water.

In an embodiment of the present invention the pre-dried fish material obtained from the pre-drying step, may have a temperature in the range of 50-99° C., such as in the range of 60-98° C., e.g. in the range of 70-96° C., such as in the range of 80-94° C., e.g. in the range of 85-92° C., such as about 90° C.

Preferably, the pre-drying step may be performed for a period between 30 minutes and 5 hours, such as for period between 45 minutes and 4 hours, e.g. for period between 1-3 hours, e.g. in the period between 1½-2 hours.

In yet an embodiment of the present invention the spin flash dryer may perform drying and milling of the pre-dried fish material providing the dry fish meal product.

Preferably, the pre-dried fish material has a residence time in the spin flash dryer of 5 minutes or less, such as 4 minutes or less, e.g. 3 minutes or less, such as 2 minutes or less, e.g. 1 minutes or less, such as 50 seconds or less, e.g. 40 seconds or less, such as 30 seconds or less, e.g. 30 seconds or less, such as 20 seconds or less, e.g. 10 seconds or less, such as 5 seconds or less, e.g. 3 seconds or less.

Preferably the temperature of the dried fish meal product coming out of the spin flash dryer may be at a temperature between about 30° C. and 100° C., more preferably between about 40° C. and 95° C., even more preferably between about 45° C. and 90° C., more preferably between about 50° C. and 85° C., even more preferably between about 55° C. and 80° C., even more preferably between about 65° C. and 79° C., even more preferably between about 70° C. and 77° C.

The dried fish meal product leaving the drying process in step (iii) may be in the form of small particles. The small particles may be separated from the gas stream, preferably this separation may be done in one or more cyclones, or by means of a bag filter or combinations of both.

It may be possible to further classify the resultant powder leaving the cyclone, like for example on a horizontal sieve for screening oversized, large particles and/or for removing dust. It may also be possible to produce different grades of feather meal, with smaller and larger particle sizes.

Reject of the sieve (oversized particles and/or dust) may preferably be reintroduced in the feed for further treatment in the drying process defined in step (iii) by mixing of reject with the wet feed material (also referred to as “back mixing”) can improve the feeding operation and overall efficiency of the drying and grinding.

Preferably, classification may be done over a sieve (or other classification device) with the cut off of 1 mm or lower, such as 800 μm or lower, e.g. 500 μm or lower, such as 300 μm or lower, depending on the product to be produced.

In an embodiment of the present invention the fish material and/or the pre-dried fish material remains at a temperature below 100° C., preferably below 95° C., more preferably below 90° C., even more preferably below 85° C., even more preferably below 80° C.

The spin flash dryer may in addition to spin flash dryers refer to air-turbulence mills; turbulent air grinding mills; vortex air mills; spin driers and grinders; flash dryers and grinders. All these are basically characterised by drying and milling wet hydrolysed material in a short period of time.

Various driers exist that are useful in the present invention offering combined drying and milling. Some constructions may offer simultaneous drying and milling, other constructions may offer an initial milling of the pre-dried fish material before the pre-dried fish material may be dried, and some constructions may offer an initial drying followed by milling of the dried fish meal.

Preferably, the pre-dried fish material may be subjected to simultaneous drying and milling, or an initial milling of the pre-dried fish material before the pre-dried fish material is dried. Most preferably the pre-dried fish material may be subjected to an initial milling of the pre-dried fish material before the material may be dried.

The drying of the pre-dried fish material performed in step (iii) may have the benefit of a fast grinding and drying-effect, and may results in combined drying and milling of the pre-dried hydrolysed material by introducing the pre-dried hydrolysed material into a flow of gas, generally air, and into a high speed rotor in a confined chamber.

The dryer may comprise a chamber (stator) with appropriate inlets and outlets for product and stream(s) of gas in which a rotating member (rotor) that can rotate at high speed. The inner walls of the stator may be lined with impacting members, like corrugated sheets, in order to increase the efficiency of the grinding with additional friction and shear forces. The rotor generally is placed vertically relative to the outlet.

In a preferred embodiment of the present invention the dryer provided in step (iii) may be providing both drying and milling. Preferably, the dryer provided in step (iii) may be a spin flash dryer.

Examples of different constructions of spin flash dryers and preferred for drying the pre-dried fish material in step (iii) of the present invention may be the spin flash dryer from Haarslev Industries, the Cell mill from Atritor, the Drymeister from Hosokawa, the Whirl flash from Larsson, The Ultra Rotor from Jackering, the Rotormill, the TurboRotor from Gorgens Mahltechnik, Dyno-JeT from Stord, or spin flash dryers from SPX. Other spin flash dryers may be described in e.g. EP 3 402 340 A1, U.S. Pat. No. 4,747,550, WO1995/028512 and WO2015/136070.

The spin flash dryer may comprise a classifier, which causes a separation of larger and smaller particles. The use of a classifier allows the larger particles to be returned to the grinder, while smaller particles are left through for further processing. In another embodiment, two or more grades of particulate fish meal may be produced, with differing particle sizes and bulk properties by having two outlets out of the classifier.

The drying may be performed with a stream of gas (generally air, preferably air that may be low in oxygen) into a high-speed rotor. The inlet temperature generally ranges between about 20° C. and 500° C., preferably between about 40° C. and 400° C. and even more preferably about 60° C. and 300° C., preferably between about 80° C. and 200° C. and even more preferably about 100° C. and 175° C., preferably about 150° C. The higher end of the temperature may require careful processing and/or may require lower amounts of the heated gas to be used. It would for example be possible to use the heated gas at a temperature of about 450° C. and a second gas stream at room temperature if high gas velocities are required.

In the present context the term “about” relates to plus or minus 20% of the value in question, such as plus or minus 10%, e.g. plus or minus 5%, such as plus or minus 2%.

The outlet temperature of the air may preferably be below 100° C., preferably below 90° C. The temperature of the inlet-gas may be lower in case the pre-dried hydrolysed material has a higher temperature.

The flow of the air generally may be about 10 m³/h per kg of fed material or lower, preferably about 8 m³/h per kg fed material or lower, preferably about 6 m³/h or less, preferably about 5 m³/h per kg fed material or less, preferably about 4 m³/h or less, preferably about 3 m³/h per kg fed material or less. Suitable, most preferred, amounts are for example between 3 and 10 m³/h per kg of fed product, such as between 4-8 m³/h per kg of fed product, e.g. between 5-6 m³/h per kg of fed product.

The gas flow may be fed into the mill directly with the feed material, or indirectly, wherein the pre-dried fish material may be fed in one place, and the gas stream may be fed into the dryer separately in one or several other places.

In an embodiment of the present invention the energy used for drying the pre-dried fish material may be about 95 Nm³/hour or less, such as about 90 Nm³/hour or less, e.g. about 85 Nm³/hour or less, such as about 80 Nm³/hour or less, e.g. about 75 Nm³/hour or less, such as about 70 Nm³/hour or less.

In a further embodiment of the present invention the energy used for drying the pre-dried fish material may be about 0.050 Nm³/kg feed or less, such as about 0.048 Nm³/kg feed or less, e.g. about 0.046 Nm³/kg feed or less, such as about 0.044 Nm³/kg feed or less, e.g. about 0.042 Nm³/kg feed or less, such as about 0.040 Nm³/kg feed or less.

Nm³/hour may relate to “Normal Cubic Metres Per Hour” of natural gas and relates to the amount of natural gas per hour necessary for providing the energy necessary for providing the dry fish meal. Nm³/kg feed relates to “Normal Cubic Metres Per Kg feed” relates to the amount of natural gas per kg feed necessary for providing the energy necessary for providing the dry fish meal.

The rotor may rotate with a tip speed of about 10 m/s or higher, such as about 15 m/s or higher, e.g. about 20 m/s or higher, such as about 25 m/s or higher, e.g. about 30 m/s or higher, such as about 40 m/s or higher, e.g. about 50 m/s or higher, such as in the range of about 10-150 m/s, e.g. in the range of 15-75 m/s, such as in the range of about 20-50 m/s, e.g. in the range of 25-30 m/s,

The gaseous flow (preferably air) may be introduced into the spin flash dryer in different ways.

Preferably, the main gas stream may be introduced at the bottom of the dryer and the gas flow may transport the product through the dryer.

In an embodiment of the present invention the pre-dried fish material may be transported into the dryer using a screw or a pump.

The inventors of the present invention surprisingly found that only applying spin flash dryers for drying the fish material may be limited by the production capacity of the spin flash dryer. The production capacity (capacity) of the spin flash dryer may be challenged by the physical dimensions and/or the energy consumption.

Preferably, an embodiment of the present invention relates to a process and a system that solves the above-mentioned problems with capacity, dimensions, complexity, and offering an economy and relevant investment and which may be environmental friendly.

The amount of energy used for drying the fish material in the combination of the first drying step (step (ii)) and in the second drying step (step (iii)) may be in the range of 40-160 MJ/kg fish material, such as in the range of 50-140 MJ/kg, e.g. in the range of 60-120 KJ/kg, such as in the range of 70-100 MJ/kg, e.g. in the range of 80-90 KJ/kg.

Preferably, the amount of energy used for drying the fish material in the combination of the first drying step (step (ii)) and in the second drying step (step (iii)), when drying to a moisture content of 4% (w/w) water, may be at least 10% lower than the amount of energy used by traditional used drying, such as at least 15% lower, e.g. at least 20% lower, such as at least 25% lower, e.g. at least 30% lower, such as at least 35% lower, e.g. at least 40% lower.

The traditional used drying may relate to traditional drying process including e.g. contact drying, like disc drying, followed by air drying (air drying different from spin flash drying).

In an embodiment of the present invention the amount of energy used for drying the fish material in the combination of the first drying step (step (ii)) and in the second drying step (step (iii)) according to the present invention, and when drying to a moisture content of 8% (w/w) water, may be at least 5% lower than the amount of energy used by spin flash drying alone, such as at least 10% lower, e.g. at least 15% lower, such as at least 20% lower, e.g. at least 25% lower, such as at least 30% lower, e.g. at least 35% lower, such as at least 40% lower.

A preferred embodiment of the present invention relates to a system comprising a first dryer which is in fluid connection with a spin flash dryer.

The system may further comprise a coagulation unit which may be in fluid connection with the first dryer.

Preferably, the coagulation unit may be a cooker.

In an embodiment of the present invention a separating unit may be inserted in between the coagulation unit and the first dryer.

The separating unit may be a filter unit, a pressing unit or a decanter unit or a combination hereof. Preferably, the separating unit may be a pressing unit or a decanter unit.

The liquid fraction and the solid fraction may be separated by a pressing unit, a filtration decanter unit or a decanter unit. Preferably, the liquid fraction and the solid fraction may be separated by using a 2-phase decanter or a 3-phase decanter. Preferably, a 3-phase decanter.

The water fraction, the oil fraction and the solid fraction may be separated by a decanter unit using a 3-phase decanter.

The solid fraction may preferably comprise a moisture content content above 50% (w/w), such as above 55% (w/w), e.g. above 60% (w/w), such as above 65% (w/w), e.g. above 70% (w/w), such as above 75% (w/w), e.g. above 80% (w/w), such as in the range of 55-85% (w/w), such as in the range of 60-80% (w/w); e.g. in the range of 62-70% (w/w).

Preferably, the pressing unit is provided with a feed inlet for introducing the cooked fish material into the pressing unit and a press liquid outlet and a press cake outlet.

The press cake outlet may be in fluid connection with the first dryer.

The system according to the present invention may relate to a process plant or part of a process plant including the relevant units.

A preferred embodiment of the present invention relates to a fish meal product obtainable by the process according to present invention.

A further preferred embodiment of the present invention relates to a fish meal product comprising a pepsin digestibility and/or the true digestibility above 80%, such as above 85%, e.g. above 90%, and a particle size when measured as d50 in volume fraction, as measured with laser diffraction using a dry powder Beckman Coulter particle size analyser, is between about 20 μm and about 0.7 mm, preferably between 0.2-0.5 mm and the d90 is below about 1 mm.

In an embodiment of the present invention, the resulting dried fish meal product may be dried in the spin flash dryer to a moisture content of about 12% (w/w) or less, preferably about 10% (w/w) or less, preferably about 8% (w/w) or less, more preferably about 6% (w/w) or less, preferably about 4% (w/w) or less. Drying to a moisture content lower than about 4% (w/w) may generally not be necessary and may harm the fish meal and reduce nutritional value. Drying the pre-dried hydrolysed material to a moisture content in the range of about 4-10% (w/w), such as in the range about 5-8% (w/w), e.g. in the range of about 6-7% (w/w), where a moisture content in the range of 5-7% (w/w) may be most preferred.

Preferably, the particle size of the dry fish meal product may not be too coarse as the flow properties and handling of the dry fish meal product may be negatively affected, e.g. causing is difficult to properly dose in preparing feed mixes. On the other hand excessive fine particles may also be undesirable as this may cause dusting when handled, sift through woven bags resulting in undesirable loss of product and in pollution, and it may cause compacting of bulk meal.

In an embodiment of the present invention the average particle size of the dried fish meal product leaving the spin flash dryer in step (iii), measured with laser diffraction using a dry powder Beckman Coulter particle size analyser, is:
when measured as d50 in volume fraction (defined as 50% of the particles may be within the stated range and 50% of the particles may be outside the stated range), between about 20 μm and about 0.7 mm, such as in the range between 50-600 μm, e.g. in the range between 100-550 μm, such as in the range of 200-450 μm, e.g. in the range of 300-400 μm,
when measured as d90 in volume fraction (defined as 90% of the particles may be within the stated range and 10% of the particles may be outside the stated range), is below about 1 mm, such as below about 800 μm, e.g. in the range of between 10-1000 μm, such as in the range of 100-900 μm, e.g. in the range of 200-800 μm, And/or
when measured as d10 in volume fraction (defined as 10% of the particles may be within the stated range and 90% of the particles may be outside the stated range), is below about 10 mm, such as below about 25 μm, e.g. below about 50 μm, such as below about 100 μm, e.g. in the range of between 10-250μm, such as in the range of 50-150 μm, e.g. in the range of 75-100 μm.

The particle size distribution of the dried fish meal product of the present invention may be relatively homogeneous. For example, the d90 divided by the d10 may be about 20 or less, such as about 15 or less, while the d90 may be about 1 mm or lower.

Preferably, the dried fish meal product may comprise an oil content of less than 20% (w/w), such as less than 18% (w/w), e.g. less than 16% (w/w), such as less than 14% (w/w), e.g. less than 12% (w/w), such as less than 10% (w/w), e.g. less than 8% (w/w), such as less than 6% (w/w), such as less than 4% (w/w), e.g. less than 2% (w/w), preferably, the dried fish meal product may comprise an oil content in the range of 6-16% (w/w), more preferably, in the range of 8-14% (w/w), more preferably, in the range of 10-12% (w/w), more preferably, in the range of 10.5-11.5% (w/w). Even more preferably, the dried fish meal product may comprise an oil content in the range of 1-16% (w/w), more preferably, in the range of 2-14% (w/w), more preferably, in the range of 3-12% (w/w), more preferably, in the range of 4-10% (w/w), more preferably, in the range of 5-8% (w/w), more preferably, in the range of 6-7% (w/w).

Fish oils, in particular the omega-3 fatty acids may oxidize when subjected to heat, light and/or oxygen. To reduce the oxidation of the fish oil one or more antioxidants may be added to the fish material, the coagulated fish material, the solid fraction, the pre-dried fish material and/or the dried fish meal product.

Preferably, the dried fish meal product may comprise one or more antioxidants. The one or more antioxidants may be added to the fish meal product and/or antioxidants may be added to the fish material during the processing of the fish material from providing the fish material until the resulting dried fish meal product, preferably from providing the fish material until (and including) the pre-dried fish material.

In an embodiment of the present invention the pre-dried fish material may be supplemented with one or more antioxidants before subjecting the pre-dried fish material to a second drying step resulting in a dried fish product.

In yet an embodiment of the present invention the dried fish meal product according to the present invention comprises a pepsin digestibility above 80, such as above 85%, e.g. above 90%, such as above 92%, e.g. above 95%, such as a pepsin digestibility in the range of 85-96%, e.g. in the range of 90-95%, such as in the range of 92-94%.

In a further embodiment of the present invention the dried fish meal product according to the present invention comprises a true digestibility above 80, such as above 82%, e.g. above 85%, such as above 87%, e.g. above 89%, such as above 92%, e.g. above 94%, such as in the range of 80-95%, e.g. in the range of 81-92%, such as in the range of 82-90%, e.g. in the range of 84-88%.

The dried fish meal product according to the present invention comprises a protein content (crude protein) above 55% (w/w), such as above 60% (w/w), e.g. above 65% (w/w), such as above 70% (w/w), e.g. above 75% (w/w), such as in the range of 50-85% (w/w), such as in the range of 55-80% (w/w), e.g. in the range of 60-75% (w/w), such as in the range of 65-70% (w/w).

In an embodiment of the present invention the fish meal product may comprise one or more antioxidants. The antioxidant may be added before drying to the fish material and/or the pre-dried fish material, and/or after drying to the dried fish meal product.

Preferably, the fish meal product may comprise a total oxidation value (TOTOX value) below 16, such as a TOTOX value below 14, e.g. a TOTOX value below 12, such as a TOTOX value below 11, e.g. a TOTOX value below 10, such as a TOTOX value below 9, e.g. a TOTOX value below 8, such as a TOTOX value below 7, e.g. a TOTOX value below 6.

The fish meal product may comprise a total TVN (total volatile nitrogen) below 50 mg of nitrogen per 100 grams of dried fish meal product, such as below 40 mg of nitrogen per 100 grams of dried fish meal product, e.g. below 30 mg of nitrogen per 100 grams of dried fish meal product, such as below 25 mg of nitrogen per 100 grams of dried fish meal product, e.g. below 20 mg of nitrogen per 100 grams of dried fish meal product, such as below 15 mg of nitrogen per 100 grams of dried fish meal product, e.g. below 10 mg of nitrogen per 100 grams of dried fish meal product.

The fish material may be provided from almost any type of marine organism or seafood, but is generally manufactured from wild-caught, small marine fish that contain a high percentage of bones and oil.

The fish material may be provided from fish which are considered unsuitable for direct human consumption, fish suitable for direct human consumption and/or bycatch and/or byproducts of trimmings made during processing (fish waste or offal) of various marine and seafood products destined for direct human consumption.

The fish material according to the present invention may be selected from anchovies, mackerel, pout, sand eel, sprat, capelin, herring, blue whiting, sardine, pilchard, sauries, menhaden, pollock and/or byproducts of trimmings made during processing of fish.

In an embodiment of the present invention 1 tons of fish material may be used for producing 100-500 kg fish meal according to the present invention, such as 150-400 kg fish meal, e.g. 200-300 kg fish meal, such as about 250 kg fish meal.

In an embodiment the method (and/or the system) of the present invention may be capable of processing more than 3 tons/hour, such as 4 tons/hour or more, e.g. 5 tons/hour or more, such as 7 tons/hour or more, e.g. 10 tons/hour or more, such as 12 tons/hour or more, e.g. 15 tons/hour or more.

The following methods may be used as suitable methods to measure the parameters stated in the description and the claims:

The fat content may be determined according to well-known methods in the industry.

The protein content may be determined by well-known methods in the industry.

The pepsin digestibility may be determined by well-known methods in the industry.

The true digestibility may be determined by well-known methods in the industry.

The particle size may be measured with laser diffraction using a dry powder Beckman Coulter particle size analyser.

Residence time may be determined by well-known methods in the industry.

It should be noted that embodiments and features described in the context of one of the aspects or one or the embodiments of the present invention also apply to the other aspects and other embodiments of the invention.

The invention will now be described in further details in the following non-limiting examples.

### EXAMPLES

Fish material comprising heads, cut-offs, and skin was coagulated in a compact coagulator under traditional conditions and the coagulated fish material was feed to a 3 phase decanter unit at a speed of 5 ton per hour providing an isolated oil fraction, a liquid fraction which was further concentrated by removing part of the water and a solid fraction (the decanter cake). The decanter cake and the concentrate were mixed in a ratio of 3:2 (decanter cake/concentrate). The solid content of the composition was 39%.

The composition was subjected to a first drying process using a disc dryer running at temperature 90° C. and for a period of 2 hours, resulting in a composition comprising a solid content of 65% (w/w)-moisture content of 35% (w/w).

The pre-dried material was then subjected to:

(a) a spin flash dryer running with an inlet air temperature of 150° C. and an outlet temperature of 77° C. and a retention time in the dryer was around 30 seconds.

The resulting dry meal comprises a fine light brown powder (visually determined). The pepsin digestibility was 95% and the fat content was 4% (w/w), and a moisture content of 6%. TVN was measured to 20 mg of nitrogen per 100 grams of dried fish meal product.

The particle size of the dried fish meal product obtained from the spin flash dryer has a D50 in the range of 300-400 μm, a D90 below 1 mm and a D10 below 25 μm. (b) a second disc dryer in smaller size compared to the one used in the first drying step (the pre-drying step) was used at a temperature of 90° C. for 3 hours.

The resulting dry meal comprises a light brown powder (visually determined). The pepsin digestibility was 90% and the fat content was 4% (w/w), and a moisture content of 6%. TVN was measured to 30 mg of nitrogen per 100 grams of dried fish meal product.

The particle size of the dried fish meal product obtained from the second disc dryer has a D50 in the range of 2-3 mm, a D90 below 4.5 mm and a D10 below 250 μm.

1. A method for providing a dried fish meal product from a fish material, the method comprising:
(i) providing a fish material;
(ii) subjecting the fish material to a pre-treatment where the water content of the fish material is reduced, wherein the pre-treatment comprises a first drying step, resulting in a pre-dried fish material, wherein the pre-dried fish material has a moisture content in the range of 15-50% (w/w) water; and
(iii) subjecting the pre-dried fish material to a second drying step resulting in a dried fish product;
wherein the second drying step performed in step (iii) is a spin flash drying process.

2. The process according to claim 1, wherein the fish material provided in step (i) is a coagulated fish material.

3. The process according to claim 1, wherein the fish material comprises an oil content in the range of 10-12% (w/w).

4. The process according to claim 1, wherein the first drying step provided in step (ii) includes an air drying process, a contact drying process, or a combination hereof.

5. The process according to claim 1, wherein the pre-dried fish material has a residence time in the spin flash dryer of 5 minutes or less, such as 4 minutes or less, e.g. 3 minutes or less, such as 2 minutes or less, e.g. 1 minutes or less, such as 50 seconds or less, e.g. 40 seconds or less, such as 30 seconds or less, e.g. 30 seconds or less, such as 20 seconds or less, e.g. 10 seconds or less, such as 5 seconds or less, e.g. 3 seconds or less.

6. A system comprising a first dryer which is in fluid connection with a spin flash dryer, wherein the system comprises a coagulation unit which is in fluid connection with the first dryer.

7. The system according to claim 6, wherein the system further comprises a coagulation unit which is in fluid connection with a first dryer.

8. The system according to claim 7, wherein a separating unit is inserted in between the coagulation unit and the first dryer.

9. A fish meal product obtainable by the process according to claim 1.

10. A fish meal product comprising a pepsin digestibility or a true digestibility above 80% and a particle size when measured as d50 in volume fraction, as measured with laser diffraction using a dry powder Beckman Coulter particle size analyser, is between about 20 μm and about 0.7 mm and the d90 is below about 1 mm, where the fish meal product comprises a total TVN (total volatile nitrogen) below 50 mg of nitrogen per 100 grams of dried fish meal product.
